(19) United States
(12) Patent Application Publication
(10) Pub. No.: US 2026/0135950 A1
(43) Pub. Date: May 14, 2026

(54) Emergency Call Routing Loop Detection and Avoidance

(71) Applicant: MOTOROLA SOLUTIONS, INC., CHICAGO, IL (US)

(72) Inventors: RAFAL KAMINSKI, WLOSAN (PL); ADRIANNA JUNG, KRAKOW (PL)

(21) Appl. No.: 18/942,817

(22) Filed: Nov. 11, 2024

(51) Int. Cl. H04M 11/04

(52) U.S. Cl. CPC H04M 11/04

(57) ABSTRACT

A call routing device maintains a call routing log that identifies previous call routing attempts for a plurality of PSAPs. When a first one of the PSAPs requests to transfer a call to a second one of the PSAPs, the call routing device determines, based on the call routing log, that a previous routing attempt to the second PSAP failed and responsively generates a list of alternate PSAPs to receive the call. The call routing device provides the list to the second PSAP, receives a selection of one of the alternate PSAPs, and transfers the call to the selected alternate PSAP.

### BACKGROUND OF THE INVENTION

In an emergency services environment that includes public safety answering points (PSAPs), a call routing device may route an emergency call to a PSAP, either as part of an initial call routing process after the emergency call is first placed or as part of a subsequent call routing process in which the call is transferred from one PSAP to another.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a system for routing calls to public safety answering points, in accordance with some examples.

FIG. 2 is a device diagram showing a device structure of a call routing device for routing calls to public safety answering points, in accordance with some examples.

FIG. 3 is a flowchart of a method for maintaining and updating a call routing log when routing calls to public safety answering points, in accordance with some examples.

FIG. 4 depicts aspects of the method for maintaining and updating a call routing log when routing calls to public safety answering points as implemented by the system of FIG. 1, in accordance with some examples.

FIG. 5 is a flowchart of a method for avoiding call routing loops when routing calls to public safety answering points, in accordance with some examples.

FIG. 6 depicts aspects of the method for avoiding call routing loops when routing calls to public safety answering points as implemented by the system of FIG. 1, in accordance with some examples.

FIG. 7 depicts further aspects of the method for avoiding call routing loops when routing calls to public safety answering points as implemented by the system of FIG. 1, in accordance with some examples.

FIG. 8 is a sequence diagram showing a variation of the method for avoiding call routing loops when routing calls to public safety answering points, in accordance with some examples.

FIG. 9 is another sequence diagram showing another variation of the method for avoiding call routing loops when routing calls to public safety answering points, in accordance with some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In an emergency services environment that includes public safety answering points (PSAPs), a call routing device may route an emergency call to a PSAP, either as part of an initial call routing process after the emergency call is first placed or as part of a subsequent call routing process in which the call is transferred from one PSAP to another.

In some instances, these routing processes can result in call routing loops in which the call routing device repeatedly fails to route the call to the same set of PSAPs. For example, when an emergency call is placed, the call routing device may determine a location associated with the call and attempt to route the call to a first PSAP that services an area that includes the location. However, the first PSAP may be unable to receive the call for various reasons (e.g., the PSAP may be at maximum call capacity or may be nonoperational), and the routing attempt may fail. Upon detecting the failed routing attempt, the call routing device may select a second PSAP as a fallback PSAP to receive the call and attempt to route the call to the second PSAP. If the second PSAP is similarly unable to receive the call, then the call routing device may select another fallback PSAP to receive the call. If the call routing device selects the first PSAP as the fallback PSAP and the first PSAP is still unable to receive the call, then the callback device may find itself in a call routing loop in which it repeatedly alternates between unsuccessful routing attempts to the first and second PSAPs.

Such a call routing loop may similarly arise when attempting to route an emergency call from one PSAP to another. For example, after a PSAP has received an emergency call, the PSAP may send a request to the call routing device to transfer the call to another PSAP for various reasons (e.g., the initial PSAP may be nearing or at maximum call capacity or may be ill-suited for assisting in an emergency response to the call). Upon receiving the request, the call routing device may attempt to route the call to the PSAP specified by the request. This routing attempt may fail for reasons similar to those referenced above, and the call routing device may engage in a similar fallback PSAP selection process that results in a similar call routing loop.

In the above examples and in those provided throughout this disclosure, it should be understood that the number of PSAPs involved in a call routing loop is not limited to two PSAPs. Rather, the above examples are for illustrative purposes only, and other examples of call routing loops may involve three or more PSAPs, such as in situations where the call routing device does not immediately select the first PSAP as a fallback PSAP after failing to route the call to the second PSAP.

In any case, the occurrence of a call routing loop can add significant delays to emergency call handling processes by preventing an emergency call from being routed to a PSAP indefinitely or until the call routing loop is eventually broken. This, in turn, delays any emergency response necessitated by the call, which could mean the difference between life and death depending on the nature of the emergency. Thus, there exists a need for an improved technical solution for dealing with call routing loops in emergency services environments.

To address these or other issues, the present disclosure provides an improved technical method, device, and system for automatically detecting and avoiding call routing loops when routing emergency calls to PSAPs. For example, a system is provided that includes a call routing device (e.g., which may include, but is not limited to a combination of one or more servers, cloud computing devices, routers, proxy devices, or the like) and a plurality of PSAPs. The call routing device receives calls, such as 9-1 -1 calls, and routes such calls to PSAPs, for example based on respective locations associated with the calls.

In order to detect and avoid call routing loops, the call routing device is configured to (i) maintain a call routing log that includes information identifying previous call routing attempts to the PSAPs and (ii) receive, from the PSAPs, status data indicating respective states of the PSAPs. Such status data may generally indicate an operational state and/or a capacity, amongst other possibilities described in more detail below, of a respective PSAP to handle calls (e.g., a number of calls presently in a queue, and a maximum queue length, or the like).

As described in further detail below, when the call routing device receives a request to route a call to one of the PSAPs, for instance when one of the PSAPs requests that a call it is currently handling be transferred to another one of the PSAPs, the call routing device leverages the information in the call routing log and the status data to (i) predict whether such a routing attempt will result in a call routing loop and (ii) if so, identify a list of alternate PSAPs to route the call to that are less likely to result in a call routing loop. The call routing device can then provide the list to the requesting PSAP, receive a selection of one of the alternate PSAPs, and route the call to the selected alternate PSAP. Any and all aspects of this process can be carried out automatically by a computing device unless explicitly stated as being performed by a human.

In this regard, a first aspect of the present specification provides a method performed by a call routing device, the method comprising: (i) maintaining a call routing log that identifies a set of previous call routing attempts for a plurality of PSAPs communicatively coupled to the call routing device; (ii) receiving call data identifying an emergency call; (iii) based on the call data, selecting a first PSAP from among the plurality of PSAPs to receive the emergency call; (iv) performing a first routing attempt to route the emergency call to the first PSAP; (v) determining that the first routing attempt is unsuccessful; (vi) based on determining that the first routing attempt is unsuccessful, performing a second routing attempt to route the emergency call to a second PSAP from among the plurality of PSAPs; (vii) determining that the second routing attempt is successful; (viii) updating the call routing log to reflect the unsuccessful first routing attempt and the successful second routing attempt; (ix) receiving, from the second PSAP, a request to transfer the emergency call from the second PSAP, wherein the request identifies the first PSAP as a target PSAP for the transfer; (x) detecting a potential call routing loop by determining, based on the call routing log, that a previous call routing attempt for routing the emergency call to the first PSAP was unsuccessful; (xi) in response to detecting the potential call routing loop, identifying, from among the plurality of PSAPs, a list of alternate target PSAPs for the call transfer from the first PSAP, wherein identifying the list of alternate target PSAPs comprises (a) determining, based on the call routing log, whether a given PSAP was a target PSAP of an unsuccessful call routing attempt for the emergency call, (b) including the given PSAP in the list of alternate target PSAPs based on the given PSAP not being the target PSAP of an unsuccessful call routing attempt for the emergency call, and (c) excluding the given PSAP from the list of alternate target PSAPs based on the given PSAP being the target PSAP of an unsuccessful call routing attempt for the emergency call; (xii) providing the list of alternate target PSAPs to the second PSAP; (xiii) receiving, from the second PSAP, a selection of a third PSAP from among the list of alternate target PSAPs; and (xiv) transferring the call from the second PSAP to the third PSAP.

In some examples of the method, identifying the list of alternate target PSAPs further comprises: (i) determining an operational state of the given PSAP; (ii) including the given PSAP in the list of alternate target PSAPs based on both (a) the given PSAP not being the target of an unsuccessful call routing attempt for the emergency call and (b) the operational state of the given PSAP indicating that the given PSAP is capable of receiving the emergency call; and (iii) excluding the given PSAP from the list of alternate target PSAPs based on either (a) the given PSAP being the target of an unsuccessful call routing attempt for the emergency call or (b) the operational state of the given PSAP indicating that the given PSAP is capable of receiving the emergency call.

In some examples of the method, the method further comprises prioritizing each of the alternate target PSAPs in the list of alternate target PSAPs based on at least one of (i) an elapsed time since a recent successful call routing attempt to each of the alternate target PSAPs, (ii) an elapsed time since a recent unsuccessful call routing attempt to each of the alternate target PSAPs, (iii) a location of each of the alternate target PSAPs, or (iv) an operational state of each of the alternate target PSAPs, wherein providing the list of alternate target PSAPs to the first PSAP comprises providing the list of alternate target PSAPs in their prioritized order.

In some examples of the method, the method further comprises prioritizing each of the alternate target PSAPs using a machine learning model trained to predict a likelihood of success of transferring the call from the second PSAP to each of the alternate target PSAPs, wherein providing the list of alternate target PSAPs to the second PSAP comprises providing the list of alternate target PSAPs in their prioritized order. Further, in some of these examples of the method, the machine learning model is configured to receive, as input feature data, data indicating at least one of (i) an elapsed time since a previous successful call routing attempt to each of the alternate target PSAPs, (ii) an elapsed time since a previous unsuccessful call routing attempt to each of the alternate target PSAPs, (iii) a location of each of the alternate target PSAPs, or (iv) an operational state of each of the alternate target PSAPs.

In some examples of the method, the method further comprises sending an indication of the detected potential call routing loop to the second PSAP.

In some examples of the method, the method further comprises, after determining that the first routing attempt is unsuccessful and prior to performing the second routing attempt: (i) performing a third routing attempt to route the emergency call to a fourth PSAP from among the plurality of PSAPs; (ii) determining that the third routing attempt is unsuccessful; (iii) identifying the first PSAP as a subsequent target PSAP for the emergency call; and (iv) detecting an additional potential call routing loop based on both (i) determining that the first routing attempt to route the emergency call to the first PSAP is unsuccessful and (ii) identifying the first PSAP as the subsequent target PSAP for the emergency call. Further, in some of these examples of the method, the method further comprises in response to detecting the additional potential call routing loop, selecting from among the plurality of PSAPs an alternate next target PSAP for the emergency call, wherein selecting the alternate next target PSAP comprises selecting a PSAP that was not a target PSAP in the potential call routing loop, and wherein selecting the alternate next target PSAP comprises selecting the second PSAP.

A second aspect of the present specification provides a call routing device comprising at least one processor and a non-transitory, computer-readable data storage comprising program instructions that, when executed by the at least one processor, cause the call routing device to perform any or all examples of the aforementioned method.

A third aspect of the present specification provides a system comprising the aforementioned call routing device and the aforementioned plurality of PSAPs communicatively coupled to the call routing device.

Each of the aforementioned aspects will be discussed in more detail below, starting with example system and device architectures of the system, in which the embodiments may be practiced, followed by an illustration of processing blocks for achieving an improved technical method, device, and system for detecting and avoiding call routing loops when routing calls to public safety answering points.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions, which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the drawings.

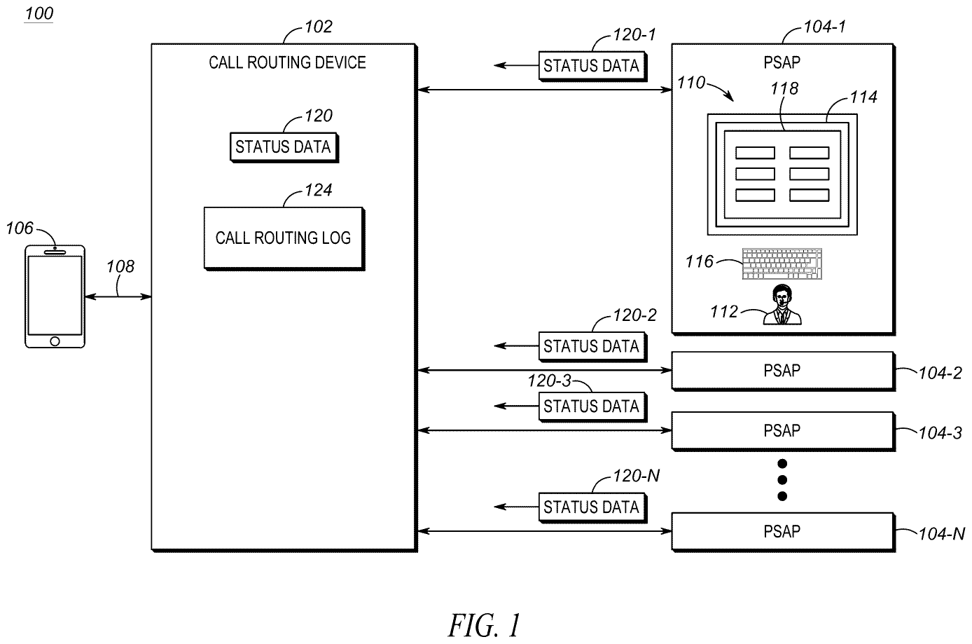

Attention is directed to FIG. 1, which depicts an example system 100 for transferring calls to public safety answering points. The various components of the system 100 are in communication via any suitable combination of wired and/or wireless communication links, and communication links between components of the system 100 are depicted in FIG. 1, and throughout the present specification, as double-ended arrows between respective components; the communication links may include any suitable combination of wireless and/or wired links, wireless and/or wired communication networks, or the like.

The system 100 comprises a call routing device 102, which may generally be configured as a call-handling device and/or call-taking device, amongst other possibilities, for a plurality of PSAPs 104-1, 104-2, 104-3. 104-N. The plurality of PSAPs 104-1, 104-2, 104-3. 104-N are interchangeably referred to hereafter, collectively, as the PSAPs 104 and, generically, as a PSAP 104. This convention will be used throughout the present specification. Furthermore, PSAP 104-1 is interchangeably referred to as the first PSAP 104-1, PSAP 104-2 is interchangeably referred to as the second PSAP 104-2, PSAP 104-3 is interchangeably referred to as the third PSAP 104-3, and so on.

As depicted, the call routing device 102 may be configured to communicate with a communication device 106 to receive a call 108 (e.g., as represented by a communication link between the communication device 106 and the call routing device 102) as a proxy for one or more of the PSAPs 104.

While an “N” number of PSAPs 104 and one communication device 106 are depicted, the system 100 may comprise any suitable number of PSAPs 104 and communication devices 106, and the call routing device 102 may be configured to receive any suitable number of calls, and provide call-handling and/or call-taking functionality for any suitable number of PSAPs 104. Hence, the number “N” may be any suitable number.

The call routing device 102 may comprise any suitable combination of one or more servers, one or more cloud computing devices, one or more routers, one or more proxy devices, or the like.

The call routing device 102 may receive an associated location with the call 108 (e.g., as metadata) and route the call 108 to an appropriate PSAP 104, for example a PSAP 104 associated with an area, location, and/or jurisdiction that includes the associated location, amongst other possibilities. In this manner, the PSAPs 104 may be associated with different areas and/or different jurisdictions (e.g., cities, towns, counties, amongst other possibilities), though such areas and/or jurisdictions may be proximal one another and/or may overlap. Hence, while different PSAPs 104 may be associated with different areas and/or different jurisdictions, the PSAPs 104 may be generally configured to handle calls, such as the call 108, associated with locations that are outside of their respective associated areas and/or respective associated jurisdictions. For example, one PSAP 104 may be configured to handle calls associated with a respective area and/or respective jurisdiction, for example to dispatch first responders to incidents in the respective area and/or respective jurisdiction; however, the PSAP 104 may be further configured to handle calls associated with respective areas and/or respective jurisdictions of the other PSAPs 104, for example to dispatch first responders to incidents in the respective areas and/or respective jurisdictions of the other PSAPs 104.

In a particular example, the call routing device 102 may include a combination of an access or service provider router, and/or any other suitable call routing devices. As the first PSAP 104-1 may be associated with an area, location, and/or jurisdiction that includes the associated location, the call routing device 102 may route the call 108 to the first PSAP 104-1, which may in turn transfer the call to a PSAP terminal 110, or another PSAP terminal, of the first PSAP 104-1. While one PSAP terminal 110 is depicted, the first PSAP 104-1 (and/or any of the other PSAPs 104) may include any suitable number of PSAP terminals 110.

As depicted, the PSAP terminal 110 may be operated by an operator 112 and comprises a display screen 114 and an input device 116 (e.g., a keyboard, as depicted, a pointing device, and/or any other suitable input device). However, the display screen 114 and the input device 116 may be provided in any suitable format (e.g., different from a PSAP terminal), such as a laptop, a personal computer, or the like (e.g., when the operator 112 is working from home and/or “off-premises” from the PSAP 104). In general, the display screen 114 and the input device 116 may be used to interact with the PSAP terminal 110, for example via an interface 118 provided at the display screen 114.

It is understood that a PSAP 104 further generally comprises call handling and/or processing components for handling calls routed thereto. It is further understood that a PSAP 104 may have a certain capacity for handling calls such that a “busyness” (e.g., how busy a PSAP 104 may be) of a PSAP 104 may affect call handling. For example, a PSAP 104 may be able to handle a maximum number of calls, which may depend on a number of PSAP terminals 110 available to handle calls (and which may change over time as operators 112 go on and off duty), and/or available processing resources at the PSAP 104 that are available to handle calls.

Further, calls routed to a PSAP 104 may be placed in a queue. Hence, capacity and/or busyness of a PSAP 104 may be represented by a number of calls in a respective queue relative to a respective maximum number of calls. Alternatively, capacity and/or busyness of a PSAP 104 may be represented by a number of calls that a PSAP 104 is presently able to handle. However, it is understood that capacity and/or busyness of a PSAP 104 may be represented in any suitable manner. Additionally, a PSAP 104 may be in a particular operational state that represents capacity and/or busyness, including but not limited to, an offline state (e.g., in which a PSAP 104 is at least temporarily unable to handle calls), or the like, amongst other possibilities.

As depicted, the PSAPs 104 may be adapted to provide respective status data 120-1, 120-2, 120-3 . . . 120-N (e.g., status data 120 and/or a set of status data 120) to the call routing device 102. The status data 120 is generally indicative of respective states of the PSAPs 104 including, but not limited to, a capacity, busyness, and/or operational state of a respective PSAP 104. The status data 120 may be received at the call routing device 102 prior to the call routing device 102 receiving the call 108.

In some examples, the status data 120 may comprise one or more of:
Respective current queue lengths of the plurality of PSAPs 104; for example, the status data 120 may comprise respective numbers of calls in a queue at a PSAP 104.
Respective maximum queue lengths of the plurality of PSAPs 104; for example, the status data 120 may comprise respective maximum numbers of calls that a PSAP 104 may maintain in a respective queue, which may depend on processing resources available to the PSAP 104, a number of terminals 110 of the PSAP 104 that are presently being operated by operators 112, amongst other possibilities.
Respective available capacity of the plurality of PSAPs 104. For example, respective available capacity for a PSAP 104 may comprise a ratio of the respective maximum numbers of calls, that a PSAP 104 may maintain in a respective queue, with the respective numbers of calls in a queue at a PSAP 104 subtracted therefrom, as compared to the respective maximum numbers of calls that a PSAP 104 may maintain in a respective queue. For example, when there are eight calls in a queue at a PSAP 104, and the maximum queue length at a PSAP 104 is twelve calls, the capacity may be expressed as 0.33 (e.g., (12−8)/12) and/or 33%. However, respective available capacity for a PSAP 104 may alternatively comprise the respective maximum numbers of calls with the respective numbers of calls in a queue at a PSAP 104 subtracted therefrom. For example, when there are eight calls in a queue at a PSAP 104, and the maximum queue length at a PSAP 104 is twelve calls, the capacity may be expressed as four calls (e.g., 12−8). However, the capacity may be provided in any suitable manner, such as on a scale of 1 to 10, or the like. In general, the higher the capacity, the more additional calls a PSAP 104 may handle, and vice versa.
Respective busyness of the plurality of PSAPs 104. For example, respective busyness of a PSAP 104 may comprise a ratio of the respective numbers of calls in a queue at a PSAP 104, as compared to the respective maximum numbers of calls that a PSAP 104 may maintain in a respective queue. For example, when there are eight calls in a queue at a PSAP 104, and the maximum queue length at a PSAP 104 is twelve calls, the busyness may be expressed as 0.67 (e.g., (8)/12) and/or 67%. However, the capacity may be provided in any suitable manner, such as on a scale of 1 to 10, or the like. In general, the higher the busyness, the fewer additional calls a PSAP 104 may handle, and vice versa.

It is understood that combinations of one or more of current queue lengths, maximum queue lengths, available capacity and busyness for a PSAP 104 may indicate a respective utilization of resources, or the like, at the PSAP 104. Hence, the status data may alternatively be generally indicative of such respective utilization.

Further, the status data 120 may indicate the state of a PSAP 104 in any suitable manner. For example, a state of a PSAP 104 may be provided in a binary manner with “0” indicating no capacity to handle more calls and/or that the PSAP 104 is inactive and/or unmanned, and “1” indicating capacity to handle more calls and/or that the PSAP is active and/or manned. For example, when a PSAP 104 is offline and/or inactive and/or unmanned, the status data 120 may comprise “0” indicating the PSAP 104 is offline and/or inactive and/or unmanned. However, when a PSAP 104 is online, and has capacity to handle calls and/or the capacity is below a threshold capacity (e.g., such as 90%, 95%, amongst other possibilities) and/or the PSAP 104 is active and/or manned, the status data 120 may comprise “1”; conversely, when a PSAP 104 is online, and capacity above the threshold capacity, the status data 120 may comprise “0”. Hence, the status data 120 may comprise a respective active or inactive state of a PSAP 104.

The status data 120 may be provided periodically by the PSAPs 104, and/or respective status data 120 may be provided by a PSAP 104 when a change to a state of the PSAP 104 changes (e.g., capacity or operational state changes), and/or the status data 120 may be provided by the PSAPs 104 upon request by the call routing device 102 (e.g., periodically and/or according to any other suitable scheme), amongst other possibilities. Furthermore, the status data 120 may be provided from a PSAP 104 to the call routing device 102 as a SIP message and/or in any other suitable format.

As further depicted, the call routing device 102 may store and maintain a call routing log 124 that includes information identifying previous call routing attempts to the PSAPs 104. The routing attempts may include both (i) call routing attempts that occur when the call is initially placed and before the call has been connected to any of the PSAPs 104, as well as (ii) call routing attempts that occur after the call has already been connected to one of the PSAPs 104, which subsequently requests the call to be transferred to another one of the PSAPs 104. Information stored in the call routing log 124 may include, for any given emergency call routing attempt, a source PSAP 104 from which the call is attempted to be routed, a target PSAP 104 to which the call 108 is attempted to be routed, whether the routing attempt was successful, the time of the routing attempt, status data 120 of the source and/or target PSAP 104 at the time of the routing attempt, and information characterizing the emergency call 108 itself, such as location information identifying a location, jurisdiction, or area from which the call 108 was placed or information identifying a phone number or other characteristics of the communication device 106 that placed the emergency call 108.

As will be described in more detail below, the call routing device 102 may use the status data 120 and the call routing log 124 as part of a process for generating lists identifying various ones of the PSAPs 104 as potential routing targets for receiving a routed emergency call. The call routing device 102 may prioritize the order of the PSAPs 104 within the lists based on a predictive success rate of routing an emergency call to each of the PSAPs 104 in the lists. Further, each list may be tailored to a particular one of the PSAPs 104 and may be provided to the particular one of the PSAPs 104 based on that PSAP 104 initiating a request to transfer an emergency call to one of the other PSAPs 104.

Throughout the present disclosure, for any example that involves attempting to route or transfer a call to a particular PSAP, that PSAP is referred to herein as a “target PSAP.” And for any example that involves attempting to route or transfer a call from a particular PSAP, that PSAP is referred to herein as a “source PSAP.”

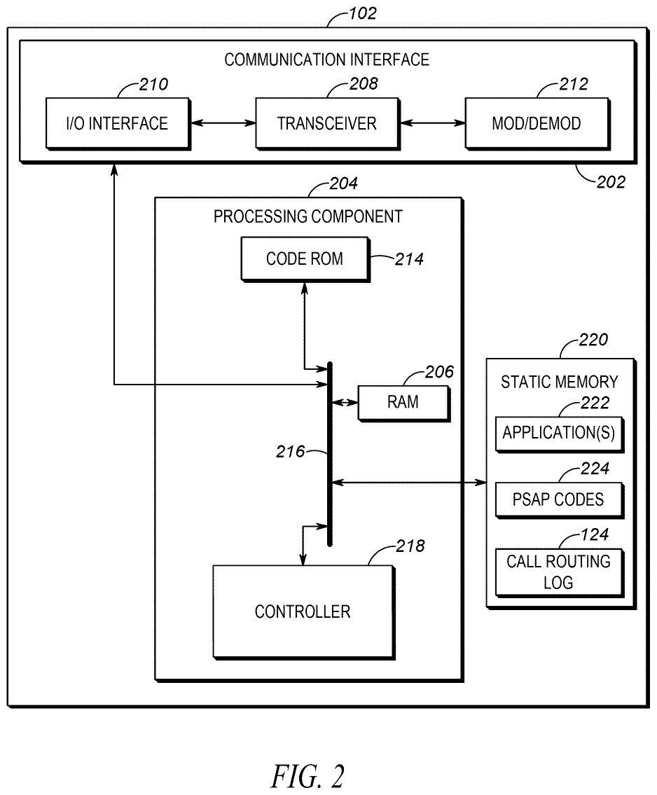

Attention is next directed to FIG. 2, which depicts a schematic block diagram of an example of the call routing device 102. While the call routing device 102 is depicted in FIG. 2 as a single component, functionality of the call routing device 102 may be distributed among a plurality of components or the like including, but not limited to, any suitable combination of one or more servers, one or more cloud computing devices, one or more routers, one or more proxy devices, or the like. In some examples, a portion of the functionality of the call routing device 102 may be integrated with one or more of the PSAPs 104.

As depicted, the call routing device 102 comprises: a communication interface 202, a processing unit 204, a Random-Access Memory (RAM) 206, one or more wireless transceivers 208 (e.g., which may be optional), one or more wired and/or wireless input/output (I/O) interfaces 210, a combined modulator/demodulator 212, a code Read Only Memory (ROM) 214, a common data and address bus 216, a controller 218, and a static memory 220 storing at least one application 222. Hereafter, the at least one application 222 will be interchangeably referred to as the application 222. Furthermore, while the memories 206, 214 are depicted as having a particular structure and/or configuration, (e.g., separate RAM 206 and ROM 214), memory of the call routing device 102 may have any suitable structure and/or configuration.

While not depicted, the call routing device 102 may include, and/or be in communication with, one or more of an input device and a display screen (and/or any other suitable notification device) or the like, such as the input device 116 and/or the display screen 114 of the PSAP terminal 110, or the like.

As shown in FIG. 2, the call routing device 102 includes the communication interface 202 communicatively coupled to the common data and address bus 216 of the processing unit 204.

The processing unit 204 may include the code ROM 214 coupled to the common data and address bus 216 for storing data for initializing system components. The processing unit 204 may further include the controller 218 coupled, by the common data and address bus 216, to the RAM 206 and the static memory 220.

The communication interface 202 may include one or more wired and/or wireless input/output (I/O) interfaces 210 that are configurable to communicate with other components of the system 100. For example, the communication interface 202 may include one or more wired and/or wireless transceivers 208 for communicating with other suitable components of the system 100. Hence, the one or more transceivers 208 may be adapted for communication with one or more communication links and/or communication networks used to communicate with the other components of the system 100. For example, the one or more transceivers 208 may be adapted for communication with one or more of the Internet, a digital mobile radio (DMR) network, a Project 25 (P25 ) network, a terrestrial trunked radio (TETRA) network, a Bluetooth network, a Wi-Fi network, for example operating in accordance with an IEEE 802.11 standard (e.g., 802.11a, 802.11b, 802.11g), an LTE (Long-Term Evolution) network and/or other types of GSM (Global System for Mobile communications) and/or 3GPP (3^{rd} Generation Partnership Project) networks, a 5G network (e.g., a network architecture compliant with, for example, the 3GPP TS 23 specification series and/or a new radio (NR) air interface compliant with the 3GPP TS 38 specification series) standard), a Worldwide Interoperability for Microwave Access (WiMAX) network, for example operating in accordance with an IEEE 802.16 standard, and/or another similar type of wireless network. Hence, the one or more transceivers 208 may include, but are not limited to, a cell phone transceiver, a DMR transceiver, P25 transceiver, a TETRA transceiver, a 3GPP transceiver, an LTE transceiver, a GSM transceiver, a 5G transceiver, a Bluetooth transceiver, a Wi-Fi transceiver, a WiMAX transceiver, and/or another similar type of wireless transceiver configurable to communicate via a wireless radio network.

The communication interface 202 may further include one or more wireline transceivers 208, such as an Ethernet transceiver, a USB (Universal Serial Bus) transceiver, or similar transceiver configurable to communicate via a twisted pair wire, a coaxial cable, a fiber-optic link, or a similar physical connection to a wireline network. The transceiver 208 may also be coupled to a combined modulator/demodulator 212.

The controller 218 may include ports (e.g., hardware ports) for coupling to other suitable hardware components of the system 100.

The controller 218 may include one or more logic circuits, one or more processors, one or more microprocessors, one or more GPUs (Graphics Processing Units), and/or the controller 218 may include one or more ASIC (application-specific integrated circuits) and one or more FPGA (field-programmable gate arrays), and/or another electronic device. In some examples, the controller 218 and/or the call routing device 102 is not a generic controller and/or a generic device, but a device specifically configured to implement functionality for transferring calls to public safety answering points. For example, in some examples, the call routing device 102 and/or the controller 218 specifically comprises a computer executable engine configured to implement functionality for transferring calls to public safety answering points.

The static memory 220 comprises a non-transitory machine-readable medium that stores machine-readable instructions to implement one or more programs or applications. Example machine-readable media include a non-volatile storage unit (e.g., Erasable Electronic Programmable Read Only Memory (“EEPROM”), Flash Memory) and/or a volatile storage unit (e.g., random-access memory (“RAM”)). In the example of FIG. 2, programming instructions (e.g., machine-readable instructions) that implement the functionality of the call routing device 102 as described herein are maintained, persistently, at the memory 220 and used by the controller 218, which makes appropriate utilization of volatile storage during the execution of such programming instructions.

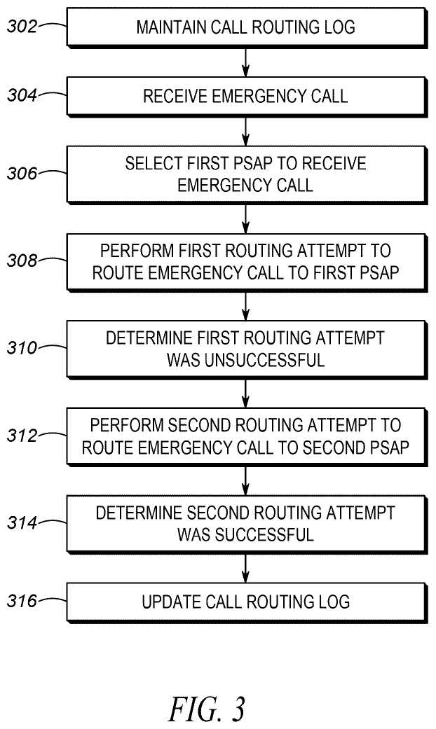

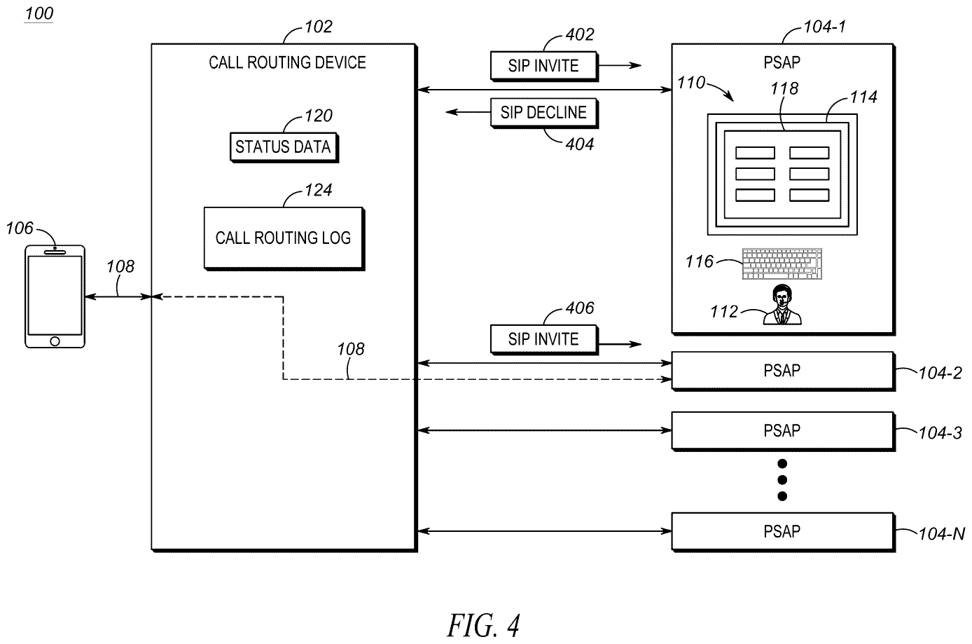

In particular, the memory 220 stores instructions corresponding to the at least one application 222 that, when executed by the controller 218, enables the controller 218 to implement functionality for transferring calls to PSAPs, including but not limited to, the blocks of the methods depicted in FIGS. 3-4 and described below.

The application 222 may include programmatic algorithms, or the like, to implement functionality as described herein. Alternatively, and/or in addition to numerical algorithms, the application 222 may include machine learning models and/or algorithms, or the like, which have been trained to implement functionality for transferring calls to public safety answering points. Furthermore, the application 222 may be operated in a training mode to train machine learning models and/or algorithms thereof to implement functionality for transferring calls to public safety answering points.

The one or more machine learning models and/or algorithms of the application 222 may include, but are not limited to: a deep-learning based algorithm; a neural network; a generalized linear regression algorithm; a random forest algorithm; a support vector machine algorithm; a gradient boosting regression algorithm; a decision tree algorithm; a generalized additive model; evolutionary programming algorithms; Bayesian inference algorithms, reinforcement learning algorithms, or the like. While generalized linear regression algorithms, random forest algorithms, support vector machine algorithms, gradient boosting regression algorithms, decision tree algorithms, generalized additive models, or the like may be preferred over neural network algorithms, deep learning algorithms, evolutionary programming algorithms, or the like, in some public safety environments, such as PSAP environments, it should be understood that any suitable machine learning algorithm and/or deep learning algorithm and/or neural network is within the scope of present examples.

As depicted, the memory 220 further stores PSAP codes 224, which may be optional, and which may comprise alphanumeric codes, or the like, mapped to network addresses of the PSAPs 104 and/or any other suitable information that enables the call routing device 102 to transfer a call to a PSAP 104 identified by a PSAP code 224. For example, a PSAP code 224 of the first PSAP 104-1 may comprise text “104-1” and may be mapped to a network address of the first PSAP 104-1, or the like; similarly, a PSAP code 224 of the second PSAP 104-2 may comprise text “104-2” and may be mapped to a network address of the second PSAP 104-2, or the like; similarly, a PSAP code 224 of the third PSAP 104-3 may comprise text “104-3” and may be mapped to a network address of the third PSAP 104-3, or the like; and, similarly, a PSAP code 224 of the N^{th} PSAP 104-N may comprise text “104-N” and may be mapped to a network address of the second N^{th} PSAP 104-N, or the like. However, any suitable codes are within the scope of the present specification. The PSAP codes 224 may be used by the components of the system 100 to identify respective PSAPs 104, and a given PSAP code 224 may be used to determine a network address of a respective PSAP 104, and/or used to transfer a call to a PSAP 104 identified by a PSAP code 224 or the like. It is understood that the PSAP codes 224 may be available and/or stored at the PSAPs 104.

As depicted, the memory 220 further stores the call routing log 124 which, as described above, includes information identifying previous call routings and/or call transfers to the PSAPs 104, and which, as described in further detail below in connection with FIGS. 3 and 4, is used to identify various ones of the PSAPs 104 as potential routing targets for receiving a routed emergency call.

While not depicted, the memory 220 may further store indications of areas and/or jurisdictions associated with respective PSAPs 104.

While the PSAP codes 224 and the call routing log 124 are depicted as being stored at the memory 220, in other examples the PSAP codes 224 and/or the call routing log 124 (and/or indications of areas and/or jurisdictions associated with respective PSAPs 104) may be stored at a memory and/or database external to the call routing device 102, that is accessible to the call routing device 102.

While details of the PSAPs 104, the PSAP terminal 110 and the communication device 106 are not depicted, the PSAPs 104, the PSAP terminal 110 and the communication device 106 may have components similar to the call routing device 102 adapted, however, for the functionality thereof.

For example, a PSAP 104 may comprise a memory (e.g., similar to the memory 220) that stores instructions corresponding to at least one application that, when executed by a controller of the PSAP 104 (e.g., similar to the controller 218), enables the controller to implement functionality for transferring calls to public safety answering points, including but not limited to, the blocks of the method set forth in FIGS. 3-4.

Attention is now directed to FIG. 3, which depicts a flowchart of a method 300 for updating a call routing log (e.g., the call routing log 124 depicted in FIGS. 1-2) that is used when routing calls to public safety answering points. The operations of the method 300 of FIG. 3 correspond to machine-readable instructions that are executed by the call routing device 102, and specifically the controller 218 of the call routing device 102. In the illustrated example, the instructions represented by the blocks of FIG. 3 are stored at the memory 220 for example, as the application 222. The method 300 of FIG. 3 is one way that the controller 218 and/or the call routing device 102 and/or the system 100 may be configured. Furthermore, the following discussion of the method 300 of FIG. 3 will lead to a further understanding of the system 100, and its various components.

The method 300 of FIG. 3 need not be performed in the exact sequence as shown and likewise various blocks may be performed in parallel rather than in sequence. Accordingly, the elements of method 300 are referred to herein as “blocks” rather than “steps.” Further, as depicted in FIG. 4, the method 300 of FIG. 3 may be implemented on variations of the system 100 of FIG. 1, as well.

At block 302, the method 300 involves the call routing device 102 maintaining a call routing log, which may take the form of the call routing log 124 described above in connection with FIGS. 1-2. In this regard, the call routing device 102 may maintain the call routing log 124 by storing in the call routing log 124 any of the information described above for identifying call routing attempts (both successful and unsuccessful) performed by the call routing device 102.

At block 304, the method 300 involves the call routing device 102 receiving (e.g., via the communication interface 202) the emergency call 108, which is to be routed to one of the PSAPs 104. The call 108 may comprise a 9-1 -1 call, or the like, which is received at the call routing device 102, as the call routing device 102 may be configured to receive 9-1-1 calls from an area where the communication device 106 is initiating the call 108.

At block 306, the method 300 involves the call routing device 102 selecting the first PSAP 104-1 as the target PSAP for receiving the call 108. The call routing device 102 may select the first PSAP 104-1 as the target PSAP based on various criteria, such as a location, jurisdiction, and/or time at which the call 108 is placed. For example, the call routing device 102 may receive a location and time of the call 108 (and/or any suitable additional data) as metadata with the call 108 (e.g., and determined by a Global Positioning System (GPS) device of the communication device 106, and/or by network components on which the call 108 is being communicated, for example using triangulation techniques). Alternatively, the call routing device 102 may determine a jurisdiction associated with the call 108 by comparing the location associated with the call 108 to the respective jurisdictions of the PSAPs 104 (e.g., stored at the memory 220) to determine a jurisdiction that includes the location associated with the call 108. Based on the determined location and/or jurisdiction information, the call routing device 102 may select the first PSAP 104-1 as the target PSAP based on the first PSAP 104-1 being associated with an area and/or jurisdiction that includes the determined location and/or jurisdiction of the call 108. Put another way, the first PSAP 104-1 may generally be configured to dispatch first responders that service the area and/or jurisdiction that includes the associated location of the call 108.

At block 308, the method 300 involves the call routing device 102 performing a first routing attempt to route the call 108 to the first PSAP 104-1. When routing calls, the call routing device 102 may employ any applicable communication protocol for call routing. In some examples, such routing communications between the call routing device 102 and the PSAPs 104 may occur according to a Sessions Initiation Protocol (SIP). In such examples, the routing and/or transferring of a call to a PSAP 104 as described herein may include exchanging SIP messages that invite a PSAP 104 to receive the call 108, but without the call 108 actually being connected to the invited PSAP 104; rather, the call 108 may be placed on hold at the call routing device 102 while the routing and/or transferring is occurring until the call 108 is connected to a PSAP 104.

As depicted in FIG. 4, for example, an attempt to route the call 108 to a PSAP 104 may be performed by the call routing device 102 sending a SIP INVITE message 402 to the first PSAP 104-1. In response to receiving the SIP INVITE message, the first PSAP 104-1 may accept the call 108 and respond with a SIP 200 OK message. However, the first PSAP 104-1 may not always accept the call 108. For instance, the first PSAP 104-1 may be offline or otherwise unavailable (e.g., due to the PSAP reaching its maximum call handling capacity), and the routing attempt may fail.

At block 310, the method 300 involves the call routing device 102 determining that the first routing attempt to route the call to the first PSAP 104-1 was unsuccessful. Continuing to use the SIP protocol as an example, the call routing device 102 may determine that the first routing attempt was unsuccessful based on the SIP INVITE message timing out or by receiving any SIP response indicating a rejection or failure of connecting the call 108. This is depicted in FIG. 4 by the first PSAP 104-1 sending a SIP DECLINE message 404 to the call routing device 102.

At block 312, based on determining that the first routing attempt was unsuccessful, the call routing device 102 performs a second routing attempt in which the call routing device 102 attempts to route the call 108 to the second PSAP 104-2, which the call routing device 102 selects as a fallback target PSAP for receiving the call 108. The call routing device 102 may select the second PSAP 104-2 as the fallback target PSAP based on any of the criteria described above for selecting the first PSAP 104-1 for the first routing attempt. For instance, the call routing device 102 may select the second PSAP 104-2 as the fallback target PSAP based on the second PSAP 104-2 being associated with an area and/or jurisdiction that includes the determined location and/or jurisdiction of the call 108. Alternatively, if there are no other PSAPs associated with the area and/or jurisdiction that includes the determined location of the call 108, then the call routing device 102 may select the second PSAP 104-2 as the fallback target PSAP based on the second PSAP 104-2 being associated with an area and/or jurisdiction that is nearest the determined location of the call 108 (excluding the first PSAP 104-1, which failed to receive the call 108). However, various other criteria for selecting the fallback target PSAP can be employed as well.

When performing the second routing attempt, the call routing device 102 may engage in similar routing communications with the second PSAP 104-2 as it did with the first PSAP 104-1 during the first routing attempt. For instance, as depicted in FIG. 4, the call routing device 102 may use the SIP protocol to route the call 108 to the second PSAP 104-2 by sending a SIP INVITE message 406 to the second PSAP 104-2.

At block 314, the method 300 involves the call routing device 102 determining that the second routing attempt was successful. Again using the SIP protocol as an example, the call routing device 102 may determine that the second routing attempt was successful based on receiving a SIP 200 OK message from the second PSAP 104-2 and connecting the call 108 to the second PSAP 104-2.

At block 316, the method 300 involves the call routing device 102 updating the call routing log 124 to reflect the first and second attempts to route the call 108. As noted above, the call routing log 124 may include any of various information for identifying routing attempts performed by the call routing device 102. In this regard, when updating the call routing log 124 to reflect the first and second attempts, the call routing device 102 may updated the call routing log 124 to include: (i) information identifying the target PSAP of each logged routing attempt; (ii) information identifying the source PSAP (or the lack thereof for a routing attempt that was initiated by the call 108 first being made rather than for a routing attempt that was initiated as a call transfer between PSAPs 104); (iii) information identifying whether the routing attempt was successful or unsuccessful; (iv) information identifying the SIP signaling between the call routing device 102 and the target PSAP (or the communications of any other call routing protocols that are employed); (v) information identifying the call 108 and/or the communication device 106 used to place the call 108; and/or (vi) timing information (e.g., timestamp data) identifying a time at which any or all of the communications were sent or received during a routing attempt.

While the method 300 depicts a specific example involving two routing attempts (a first unsuccessful attempt followed by a second successful attempt), it should be understood that this example is for illustrative purposes only and that other examples may involve additional or fewer routing attempts before the call routing device 102 is ultimately able to successfully route the call 108 to one of the PSAPs 104.

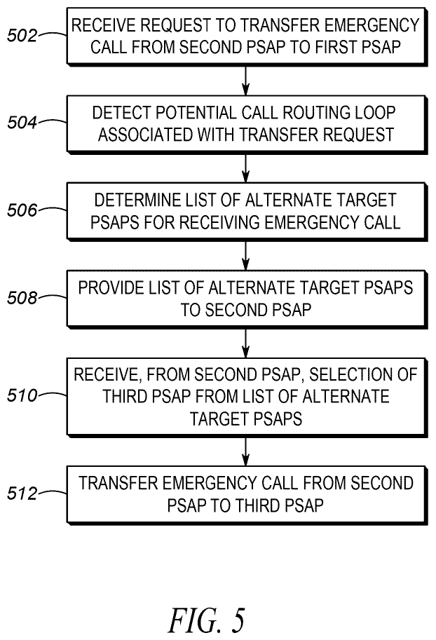

By performing the method 300 to update the call routing log 124 for each routing attempt performed by the call routing device 102, the call routing device 102 creates a robust dataset that the call routing device 102 can leverage to generate call routing recommendations that are less likely to result in unsuccessful routing attempts and call routing loops, as will be described in further detail below in connection with FIGS. 5-7.

Attention is now directed to FIG. 5, which depicts a flowchart of a method 500 for using a call routing log (e.g., the call routing log 124 described above in connection with FIGS. 1-4) to reduce or prevent the occurrence of call routing loops when routing calls to public safety answering points. The operations of the method 500 of FIG. 5 correspond to machine-readable instructions that are executed by the call routing device 102, and specifically the controller 218 of the call routing device 102. In the illustrated example, the instructions represented by the blocks of FIG. 5 are stored at the memory 220 for example, as the application 222. The method 500 of FIG. 5 is one way that the controller 218 and/or the call routing device 102 and/or the system 100 may be configured. Furthermore, the following discussion of the method 500 of FIG. 5 will lead to a further understanding of the system 100, and its various components.

The method 500 of FIG. 5 need not be performed in the exact sequence as shown and likewise various blocks may be performed in parallel rather than in sequence. Accordingly, the elements of method 500 are referred to herein as “blocks” rather than “steps.” The method 500 of FIG. 5 may be implemented on variations of the system 100 of FIG. 1, as well.

Further, in the present example, the method 500 of FIG. 5 is carried out after the performance of the method 300 of FIG. 3, such that the call routing log 124 reflects the first and second routing attempts performed in method 300, and the call 108 is successfully routed and connected to the second PSAP 104-2. However, it should be understood that this arrangement is for illustrative purposes only and that the method 500 can be applied to other scenarios as applicable.

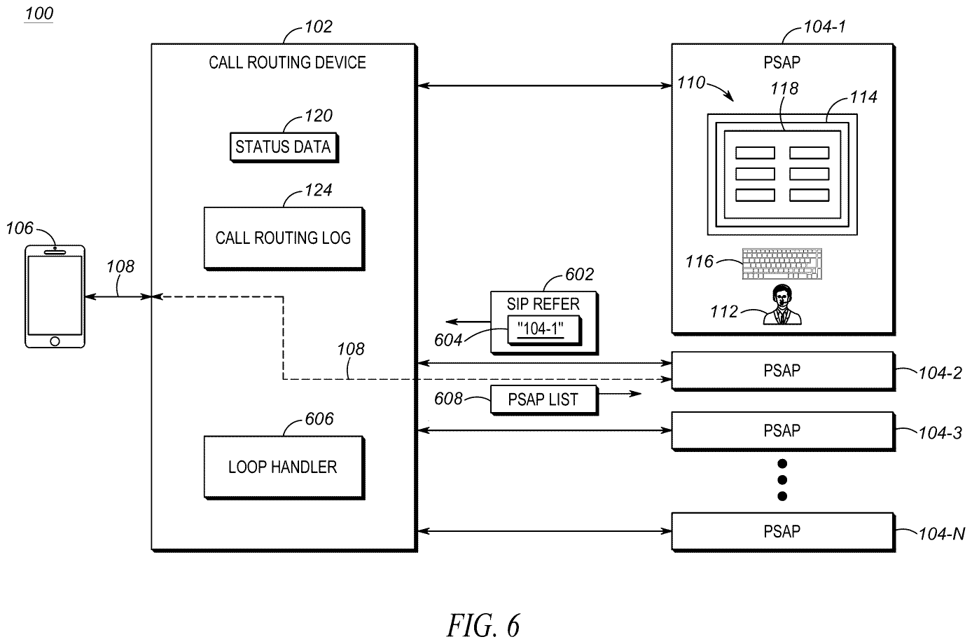

At block 502, the method 500 involves the call routing device 102 receiving a request to transfer the emergency call 108 from the second PSAP 104-2 to the first PSAP 104-1. Still continuing with the SIP protocol example, and as depicted in FIG. 6, the call routing device 102 may receive such a request via a SIP REFER message 602. The SIP REFER message 602 (or whatever other form the transfer request takes) may comprise a code 604 (which may correspond to one of the PSAP codes 224 described above in connection with FIG. 2) identifying the first PSAP 104-1, and the call routing device 102 may identify the first PSAP 104-1 from the code 604. For example, the SIP REFER message may identify the first PSAP 104-1 using a respective PSAP code 224, such as “104-1,” or the like.

At block 504, the method 500 involves the call routing device 102 detecting a potential call routing loop that would result from performing the call transfer requested and received at block 502 (i.e., transferring the call from the second PSAP 104-2 to the first PSAP 104-1 in the present example). This may involve determining that a previous routing attempt for routing an emergency call to the first PSAP 104-1 was unsuccessful. To make such a determination, the call routing device 102 may refer to the call routing log 124, which as described above includes information identifying previous call routing attempts performed by the call routing device 102, as well as information identifying the PSAPs 104 involved in the attempts and whether the attempts were successful. Thus, at block 504, the call routing device 102 may access the call routing log and, based on the information in the call routing log 124, determine that a previous routing attempt for routing an emergency call to the first PSAP 104-1 was unsuccessful.

In some examples, when making the determination at block 504, the call routing device 102 may only consider a portion of the call routing log 124. As one example, the call routing device 102 may only consider information in the call routing log 124 corresponding to routing attempts performed in connection with the particular call that is being transferred (i.e., call 108). As another example, the call routing device 102 may only consider information in the call routing log 124 corresponding to routing attempts performed during a predefined time period, such as a time period extending backward in time from the current time by a predefined amount.

The determination at block 504 that a previous routing attempt for routing an emergency call to the first PSAP 104-1 was unsuccessful might indicate that performing another attempt to route a call to the first PSAP 104-1 could similarly result in failure, and thereby potentially result in a call routing loop as described above. Accordingly, based on the determination at block 504, at block 506 the call routing device 102 may determine a list 608 of alternate target PSAPs different from PSAP 104-1 for receiving the emergency call 108 that is being transferred from the second PSAP 104-2.

In order to determine the list of alternate target PSAPs, the call routing device 102 may further include a loop handler 606, as depicted in FIG. 6, which may comprise machine-readable instructions that are stored at the memory 220 (e.g., as part of the application 222) and executed by the call routing device 102. The loop handler 606 may be configured to identify the alternate target PSAPs that are most likely to be available to receive the call 108 that is being transferred from the second PSAP 104-2 and responsively include those PSAPs in the list 608 of alternate target PSAPs.

The loop handler 606 may identify the alternate target PSAPs for inclusion in the list 608 in various ways. In some examples, the loop handler 606 may do so based on whether each of the PSAPs 104 was previously a target PSAP of an unsuccessful routing attempt for the call 108 or for some other call (e.g., within a predefined time period, such as a time period extending backward in time from the current time by a predefined amount). For instance, in the present example, the loop handler may determine, based on the call routing log 124, that the first PSAP 104-1 was a target PSAP of an unsuccessful routing attempt for the emergency call 108 and, based on this determination, exclude the first PSAP 104-1 from the list 608 of alternate target PSAPs. As another example, the loop handler may determine, based on the call routing log 124, that the third PSAP 104-3 was the target of an unsuccessful routing attempt for a different emergency call within a recent predefined time period (e.g., within the last thirty minutes, hour, day, etc.) and, based on this determination, exclude the third PSAP 104-3 from the list 608 of alternate target PSAPs. Conversely, the loop handler 606 may include in the list 608 any of the other PSAPs 104 that were not target PSAPs in such unsuccessful routing attempts.

In some examples, the loop handler 606 may additionally use the status data 120 as a basis for including or excluding PSAPs 104 to or from the list 608. For instance, the loop handler 606 may determine, based on the status data 120, that one of the PSAPs 104 has an operational state that is not conducive to receiving additional calls (e.g., the status data 120 indicates that the PSAP is offline or at or near maximum call handling capacity), and the loop handler 606 may responsively exclude that PSAP 104 from the list 608 even if the PSAP 104 was not the target of a recent unsuccessful routing attempt. Conversely, for a PSAP 104 that was the target PSAP of a recent unsuccessful routing attempt, the loop handler 606 may nonetheless include the PSAP 104 in the list 608 based on certain conditions in the status data 120. For example, if the status data 120 indicates that the PSAP 104 was at or near maximum call capacity at the time of the recent unsuccessful routing attempt but that the PSAP 104 is no longer at or near its maximum call capacity, then the loop handler 606 may include the PSAP 104 in the list 608.

Further, in some examples, the loop handler 606 may include one or more machine learning models trained to predict a likelihood (e.g., a probability between 0 and 1) that a particular one of the PSAPs 104 will successfully receive a call routed to it from another one of the PSAPs 104. Such an example machine learning model may take the form of a model trained using a supervised learning process in which the training data for a given routing attempt is assigned a label representing a successful routing attempt (e.g., a probability value of 1) or an unsuccessful routing attempt (e.g., a probability value of 0). The training data may include input features extracted from the status data 120 and/or the call routing log 124 and may include any data that is reflective of a potential target PSAP's ability to receive a call from a potential source PSAP. Examples of such input features may include one or more of: (i) an identifier of the target PSAP (e.g., one of the PSAP codes 224), (ii) an elapsed time since a previous successful call routing attempt to the target PSAP and/or an identifier of any source PSAP (e.g., one of the PSAP codes 224) from which the call was successfully routed, (iii) an elapsed time since a previous unsuccessful call routing attempt to the target PSAP and/or an identifier of any source PSAP (e.g., one of the PSAP codes 224) from which the call was unsuccessfully routed, (iv) a location, area, and/or jurisdiction serviced by or otherwise associated with the target PSAP and/or the source PSAP, (v) an operational state of the target PSAP and/or the source PSAP, or (vi) a call handling capacity of the target PSAP and/or the source PSAP. It should be understood, however, that different types of machine learning models trained with different input feature data could be used as applicable for predicting whether a call routing attempt will be successful.

Still further, in some examples, the loop handler 606 may include one or more non-machine-learning, or rule-based, algorithms for predicting a likelihood (e.g., a probability between 0 and 1) that a particular one of the PSAPs 104 will successfully receive a call routed to it from another one of the PSAPs 104 based on historical success rates indicated by the call routing log 124. For example, the loop handler 606 may determine, based on the data in the call routing log, the rate at which calls associated with an area and/or jurisdiction of a given PSAP 104 were historically routed to, but not accepted by, the given PSAP 104 and transferred to another PSAP 104. In a specific example, the call routing log 124 may indicate that calls not accepted by the first PSAP 104-1 were transferred to the second PSAP 104-2, which consistently also did not accept the calls, but that calls routed to the third PSAP 104-3 were consistently accepted by the third PSAP 104-3. While the term “consistently” is relative, such consistency may be based on thresholds, amongst other possibilities. For example, when a percentage of calls above a threshold percentage of 75%, 85%, 90%, 95%, amongst other possibilities, are not accepted by the second PSAP 104-2, the loop handler 606 may determine that the second PSAP 104-2 consistently did not accept calls. Similarly, when a percentage of calls above a respective threshold percentage of 75%, 85%, 90%, 95%, amongst other possibilities, are accepted by the third PSAP 104-3, the loop handler 606 may determine that the third PSAP 104-3 consistently accepts calls.

Regardless of whether the loop handler 606 uses a machine learning approach or a rule-based approach as described above, the loop handler 606 may determine predicted probabilities of success for routing the call 108 from the second PSAP 104-2 to each of the other PSAPs 104-1 and may select only those PSAPs 104 that have a predicted probability of success over a threshold amount for inclusion in the list of alternate target PSAPs.

When generating the list 608, the loop handler 606 may further prioritize the alternate target PSAPs 104 included in the list 608 according to various criteria, including any of the applicable criteria described above as a basis for inclusion or exclusion from the list 608. For instance, in examples where the loop handler 606 determines a predicted likelihood of success of routing attempts for each of the alternate target PSAPs 104 included in the list 608, the loop handler 606 may rank the alternate target PSAPs 104 according to their predicted likelihood of success. Alternatively, the loop handler 606 may rank the alternate target PSAPs 104 that are included in the list 608 in a particular order based on one or more of: (i) an elapsed time since a recent successful call routing attempt to each of the alternate target PSAPs, (ii) an elapsed time since a recent unsuccessful call routing attempt to each of the alternate target PSAPs, (iii) a location of each of the alternate target PSAPs, or (iv) an operational state of each of the alternate target PSAPs.

At block 508, once the loop handler 606 has determined the list 608 of alternate target PSAPs, the call routing device 102 provides the list 608 of alternate target PSAPs to the second PSAP 104-2, as shown in FIG. 6. The call routing device 102 may send the list 608 to the second PSAP 104-2 via the communication interface 202 in any of various forms, such as in the form of a SIP message. However, the list 608 may be sent using any other applicable communication protocol as well.

At block 510, the call routing device 102 receives, via the communication interface 202, from the second PSAP 104-2, a selection of one of the alternate target PSAPs from the list 608.

The second PSAP 104-2 may provide the selection of one of the alternate target PSAPs in various ways. In some examples, the second PSAP 104-2 may cause the display screen 114 to provide an indication of the call 108 along with the list 608, and the operator 112 may operate the input device 116 to select a PSAP 104 from the list 608. In the present example, the third PSAP 104-3 may have the highest priority in the list 608, and the operator 112 may select the third PSAP 104-3 based on it having the highest priority. However, the operator 112 may select a different PSAP 104 in other examples.

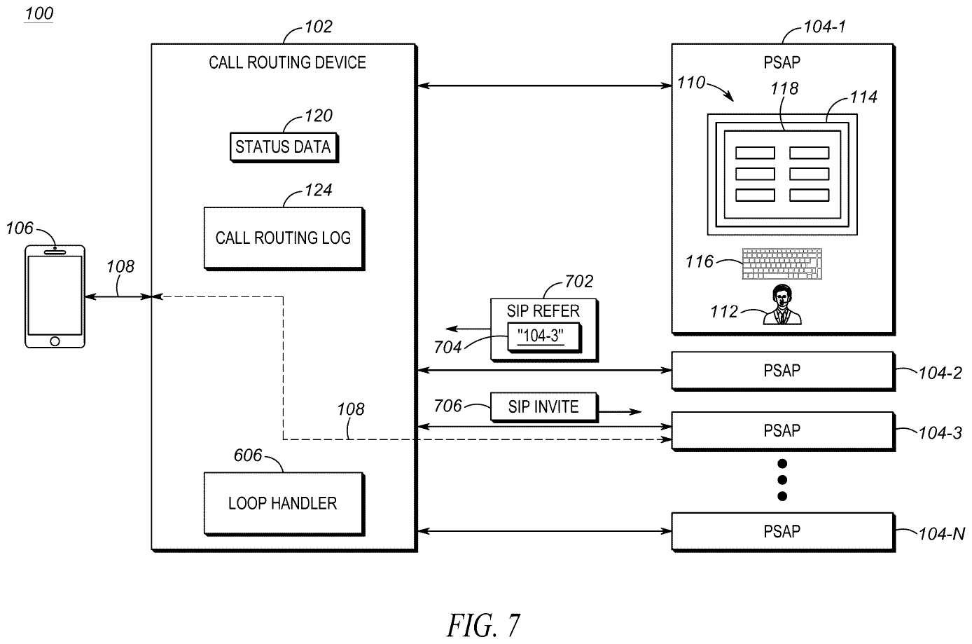

Based on the operator 112 selecting the third PSAP 104-3 from the list 608, the second PSAP 104-2 sends an indication of the selected third PSAP 104-3 to the call routing device 102. The second PSAP 104-2 can send the indication in various ways. In some examples, and as depicted in FIG. 7, the second PSAP 104-2 may send the indication in the form of a SIP message, such as a SIP REFER message 702 that includes an identification 704 of the third PSAP 104-3 using one of the PSAP codes 224, such as “104-3,” or the like.

At block 512, in response to receiving the selection of the third PSAP 104-3 from among the alternate target PSAPs in the list 608, the call routing device 102 transfers the call 108 to the third PSAP 104-3. As depicted in FIG. 7, the call routing device 102 may transfer the call 108 to the third PSAP 104-3 using the SIP signaling process described above. For example, the call routing device 102 provides a SIP INVITE message 706 to the third PSAP 104-3, which accepts the call 108 (e.g., by sending a SIP 200 OK message to the call routing device 102). Based on this SIP signaling, the call routing device 102 connects the call 108 to the third PSAP 104-3, as indicated by a dashed line that represents a portion of a communication link between the communication device 106 and the third PSAP 104-3. While FIG. 7 depicts the connection of the call 108 as passing through the call routing device 102, in other examples the connection may occur external to the call routing device 102, for example via SIP messages provided to network components that provide communication links between the communication device 106 and the third PSAP 104-3.

While the method 500 involves techniques for avoiding call routing loops after the call 108 is already being handled by one of the PSAPs 104 and when transferring the call 108 to another one of the PSAPs 104, aspects of the method 500 that involve using the call routing log 124 to avoid call routing loops may also be applied earlier in the call routing process when the call 108 is first routed to one of the PSAPs 104. To illustrate, consider the example described above in connection with FIG. 3 in which the routing attempt to route the call 108 to the first PSAP 104-1 was unsuccessful, and the routing attempt to route the call 108 to the second PSAP 104-2 was successful. In particular, consider an example in which the call routing device 102, attempts to route the call 108 to a different PSAP, such as the fourth PSAP 104-4, before routing the call to the second PSAP 104-2. This may occur if the call routing device 102 chooses the fourth PSAP 104-4 as the fallback target PSAP instead of the second PSAP 104-2 based on any of the criteria described above for selecting a fallback target PSAP. In this example, the routing attempt to the fourth PSAP 104-4 is also unsuccessful, such that the call routing device 102 must select another fallback target PSAP for the call 108. Conventional call routing devices might return to the first PSAP 104-1 as the next fallback device, which could result in a call routing loop that repeatedly bounces between the first PSAP 104-1 and the fourth PSAP 104-4. The call routing device 102 disclosed herein, however, may leverage the call routing log 124 to avoid such a call routing loop. For example, in response to determining that the call routing attempt to the fourth PSAP 104-4 was unsuccessful, the call routing device 102 may determine, based on the call routing log 124, that the initial routing attempt to the first PSAP 104-1 was unsuccessful and responsively determine that a subsequent routing attempt to the first PSAP 104-1 could result in a potential call routing loop. And based on this detection of a potential call routing loop, the call routing device 102 may instead select a different one of the PSAPs 104 to receive the call 108. Namely, the call routing device 102 may select one of the PSAPs 104 that is not included in the detected potential call routing loop (i.e., a PSAP 104 different from the first PSAP 104-1 and the fourth PSAP 104-4), which in the above-described example is the second PSAP 104-2.

Further, in some examples, different aspects of the method 500 may be varied to account for different capabilities of the PSAPs 104. For instance, in order to facilitate performance of the method 500 as described above, some or all of the PSAPs 104 may be provisioned with program instructions that allow the PSAPs to receive and process the PSAP list 608 in the manner described above (e.g., in order to receive the PSAP list 608 and provide a selection of one of the alternate target PSAPs in the PSAP list 608). However, different PSAPs may have different capabilities, so there may be examples in which one or more of the PSAPs 104 is not programmed to receive and process the PSAP list 608.

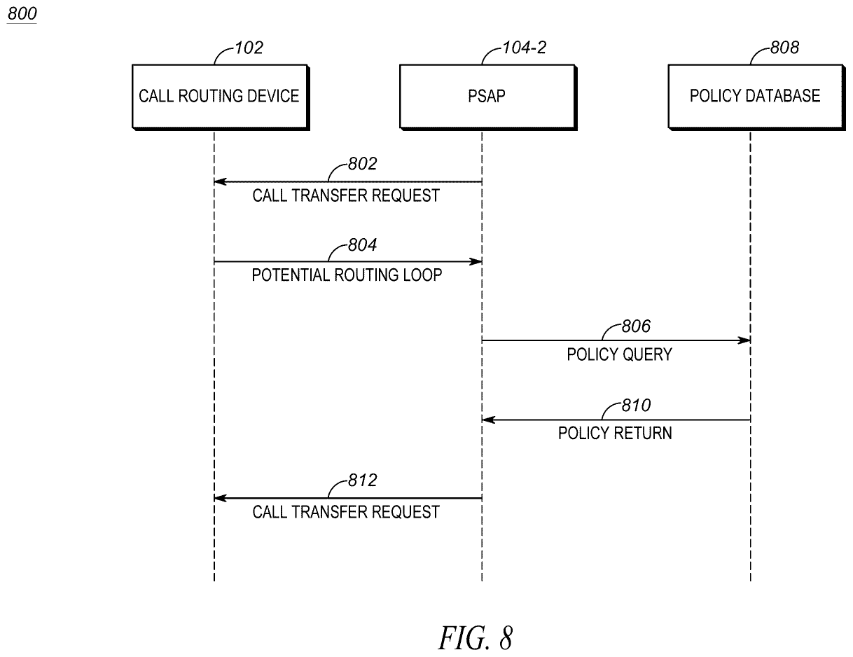

Accordingly, in some examples of the method 500, when the call routing device 102 detects a potential call routing loop, the call routing device 102 may send an indication of the potential loop to the source PSAP requesting the call transfer (e.g., the second PSAP 104-2 in the examples described herein) either in advance of or concurrently with the PSAP list 608. If the source PSAP is capable of processing the PSAP list 608, then the source PSAP may proceed to do so and select an alternate target PSAP. If, however, the source PSAP is unable to process the PSAP list 608, then the source PSAP may take other measures to prevent the potential loop, such as those described in further detail below in connection with FIG. 8.

As yet another example, the call routing device 102 may determine whether the source PSAP requesting the call transfer is capable of receiving and processing the PSAP list 608 prior to sending it to the source PSAP. For example, at block 504, when the call routing device 102 detects that a potential call routing loop could occur during the requested call transfer from the second PSAP 104-2 to the first PSAP 104-1 (based on the determination that a previous routing attempt to the first PSAP 104-1 was unsuccessful), the call routing device 102 may notify the second PSAP 104-2 of the potential call routing loop. For instance, the call routing device 102 may send a SIP message (or a message according to any of various other protocols) to the second PSAP 104-2 indicating the detection of the potential call routing loop. In examples where the second PSAP 104-2 is capable of receiving the PSAP list 608, the second PSAP 104-2 may respond to the loop detection message with a SIP message (or the like) requesting the PSAP list 608 or otherwise indicating that the second PSAP 104-2 is capable of receiving the PSAP list 608. The remainder of the method 500 can then be carried out in the manner described above.

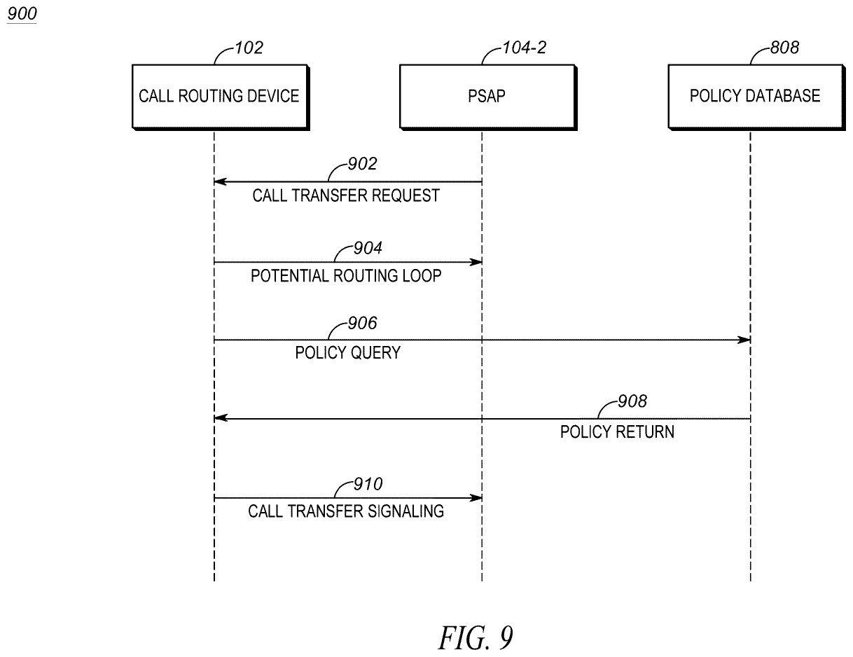

In examples where the second PSAP 104-2 is not capable of receiving and processing the PSAP list 608 from the call routing device 102, the call routing device 102 and/or the second PSAP 104-2 may employ alternative techniques for avoiding a call routing loop. Attention is now directed to FIGS. 8 and 9, which depict sequence diagrams 800, 900 of examples of such alternative techniques.

Referring first to FIG. 8, the sequence diagram 800 depicts the call routing device 102 receiving a call transfer request 802 from the second PSAP 104-2. This may be the same call transfer request described above at block 502 of the method 500. Based on the call transfer request 802, the call routing device 102 detects a potential resultant call routing loop, such as by performing the techniques described above at block 504 of the method 500. In response to detecting the potential call routing loop, the call routing device 102, sends an indication 804 of the call routing loop to the second PSAP 104-2.

Once the second PSAP 104-2 has been notified of the potential call routing loop, the second PSAP 104-2 may apply its own loop avoidance policy to select an alternate target PSAP. In order to apply its own loop avoidance policy, the second PSAP 104-2 may send a policy query 806 to a policy database 808. The policy database 808 may be located at the second PSAP 104-2 (e.g., in a local data storage of the second PSAP 104-2) or may be located remotely from the second PSAP 104-2 (e.g., in a remote server accessible via a communication network) and may store, or otherwise have access to, a predefined call routing loop avoidance policy for selecting an alternate target PSAP when a potential routing loop is detected. Such a policy may take various forms. In some examples, the policy may include a prioritized list of alternate target PSAPs similar to the PSAP list 608. However, instead of being generated by the call routing device 102, the second PSAP 104-2 may generate the list according to its own preferences or by using any of the above-described techniques for generating the PSAP list 608. Such a policy database 808 and/or call routing loop avoidance policy can be implemented for any or all of the PSAPs 104.

In response to receiving the policy query 806, the policy database 808 sends a policy return message 810 to the second PSAP 104-2. The policy query 806 and the policy return message 810 may take various forms. In some examples, the query 806 may include a simple request for the prioritized list of alternate target PSAPs or for the highest priority alternate target PSAP pursuant to the predefined call routing loop avoidance policy. And the policy return message 810 may include the requested information. In other examples, the query 806 may pass along certain data that the policy database 808 may use to determine the prioritized list of alternate target PSAPs or the highest priority alternate target PSAP. Such data may include any of the data described above used for generating the PSAP list 608. Once the policy database 808 has processed this data to determine the prioritized list of alternate target PSAPs or the highest priority alternate target PSAP, the policy database 808 may provide this information to the second PSAP 104-2 in the policy return message 810.

Based on the policy return message 810, the second PSAP 104-2 may select an alternate target PSAP and may send an indication of the selected alternate target PSAP to the call routing device 102. As depicted, the indication of the selected alternate target PSAP may take the form of a subsequent call transfer request 812 (e.g., a SIP REFER message identifying the alternate target PSAP similar to the SIP REFER message 602 identifying the third PSAP 104-3). And if the call routing device 102 determines that this newly selected alternate target PSAP would similarly result in a potential call routing loop (e.g., using any of the techniques described herein), then the call routing device 102 and the second PSAP 104-2 can repeat this process until the loop avoidance policy of the second PSAP 104-2 results in the selection of an alternate target PSAP that the call routing device does not identify as a cause of a potential call routing loop.

Turning next to FIG. 9, another sequence diagram 900 showing a variation of the method 500 is depicted. The sequence diagram 900 of FIG. 9 begins the same way as the sequence diagram 800 of FIG. 8, in that the call routing device 102 receives a call transfer request 902 from the second PSAP 104-2, and, based on the call transfer request 902, the call routing device 102 detects a potential call routing loop and sends an indication 904 of the potential loop to the second PSAP 104-2. However, in this example, the call routing device 102 accesses the call routing loop avoidance policy for the second PSAP 104-2.

As shown, the call routing device 102 sends a policy query 906 to the policy database 808, and the policy database 808 responds with a policy return message 908. The policy query 906 and the policy return message 908 of FIG. 9 may take the same or similar form as the policy query 806 and the policy return message 810 of FIG. 8. In this manner, the call routing device 102 may select an alternate target PSAP that complies with the predefined call routing loop avoidance policy of the second PSAP 104-2 and may transfer the call to the selected alternate target PSAP. This may involve sending call transfer signaling 910 to the second PSAP 104-2 (e.g., to disconnect the call from the second PSAP 104-2, to notify the second PSAP 104-2 of a successful call transfer and/or to identify the PSAP 104 to which the call was transferred).

In the above examples, the policy database 808 may be implemented as part of the Emergency Call Routing Function (ECRF) component of the Next Generation 9-1 -1 Core Services (NGCS). In conventional systems, call routing devices use ECRF to identify a target PSAP based on the location from where an emergency call is placed. Namely, a call routing device will send to an ECRF server a query that includes the location of the call as well as a Service Uniform Resource Name (URN) that identifies the type of service requested for the call. The Service URN for a 9-1 -1 call, for example, is urn:emergency:service:sos, and when a call routing device queries an ECRF server with this Service URN and corresponding call location data, the ECRF employs a Location-to-Service Translation (LoST) protocol to map the location to an appropriate corresponding PSAP.

Applying these capabilities to the present disclosure, an ECRF server may be configured to receive a new type of Service URN corresponding to a detected call routing loop, such as urn:emergency:service:loop or the like. This Service URN may be included in the policy query 906 with various other information that the ECRF server may use to identify the appropriate call routing loop avoidance policy, such as an identifier of the source PSAP requesting the call transfer. Upon receiving such a query, the ECRF server may map the source PSAP identifier to a network address (e.g., a Uniform Resource Locator (URL)) where the call routing loop avoidance policy for the source PSAP can be accessed. The ECRF server may then include this network address in the policy return message 908, which the call routing device 102 can use to access and apply the call routing loop avoidance policy.

As should be apparent from this detailed description above, the operations and functions of the call routing device 102 are sufficiently complex as to require their implementation on a computer system, and cannot be performed, as a practical matter, in the human mind. Electronic computing devices such as those set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot route calls to and from PSAPs, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A call routing device for routing calls to public safety answering points (PSAPs), the call routing device comprising:
at least one processor; and
non-transitory, computer-readable data storage comprising program instructions that, when executed by the at least one processor, cause the call routing device to perform a set of operations comprising:
maintaining a call routing log that identifies a set of previous call routing attempts for a plurality of PSAPs communicatively coupled to the call routing device;
receiving call data identifying an emergency call;
based on the call data, selecting a first PSAP from among the plurality of PSAPs to receive the emergency call;
performing a first routing attempt to route the emergency call to the first PSAP;
determining that the first routing attempt is unsuccessful;
based on determining that the first routing attempt is unsuccessful, performing a second routing attempt to route the emergency call to a second PSAP from among the plurality of PSAPs;
determining that the second routing attempt is successful;
updating the call routing log to reflect the unsuccessful first routing attempt and the successful second routing attempt;
receiving, from the second PSAP, a request to transfer the emergency call from the second PSAP, wherein the request identifies the first PSAP as a target PSAP for the transfer;
detecting a potential call routing loop by determining, based on the call routing log, that a previous call routing attempt for routing the emergency call to the first PSAP was unsuccessful;
in response to detecting the potential call routing loop, identifying, from among the plurality of PSAPs, a list of alternate target PSAPs for the call transfer from the first PSAP, wherein identifying the list of alternate target PSAPs comprises (i) determining, based on the call routing log, whether a given PSAP was a target PSAP of an unsuccessful call routing attempt for the emergency call, (ii) including the given PSAP in the list of alternate target PSAPs based on the given PSAP not being the target PSAP of an unsuccessful call routing attempt for the emergency call, and (iii) excluding the given PSAP from the list of alternate target PSAPs based on the given PSAP being the target PSAP of an unsuccessful call routing attempt for the emergency call;
providing the list of alternate target PSAPs to the second PSAP;
receiving, from the second PSAP, a selection of a third PSAP from among the list of alternate target PSAPs; and
transferring the call from the second PSAP to the third PSAP.

2. The call routing device of claim 1, wherein identifying the list of alternate target PSAPs further comprises:
determining an operational state of the given PSAP;
including the given PSAP in the list of alternate target PSAPs based on both (i) the given PSAP not being the target of an unsuccessful call routing attempt for the emergency call and (ii) the operational state of the given PSAP indicating that the given PSAP is capable of receiving the emergency call; and
excluding the given PSAP from the list of alternate target PSAPs based on either (i) the given PSAP being the target of an unsuccessful call routing attempt for the emergency call or (ii) the operational state of the given PSAP indicating that the given PSAP is capable of receiving the emergency call.

3. The call routing device of claim 1, the set of operations further comprising:
prioritizing each of the alternate target PSAPs in the list of alternate target PSAPs based on at least one of (i) an elapsed time since a recent successful call routing attempt to each of the alternate target PSAPs, (ii) an elapsed time since a recent unsuccessful call routing attempt to each of the alternate target PSAPs, (iii) a location of each of the alternate target PSAPs, or (iv) an operational state of each of the alternate target PSAPs, wherein providing the list of alternate target PSAPs to the first PSAP comprises providing the list of alternate target PSAPs in their prioritized order.

4. The call routing device of claim 1, the set of operations further comprising:
prioritizing each of the alternate target PSAPs using a machine learning model trained to predict a likelihood of success of transferring the call from the second PSAP to each of the alternate target PSAPs, wherein providing the list of alternate target PSAPs to the second PSAP comprises providing the list of alternate target PSAPs in their prioritized order.

5. The call routing device of claim 4, wherein the machine learning model is configured to receive, as input feature data, data indicating at least one of (i) an elapsed time since a previous successful call routing attempt to each of the alternate target PSAPs, (ii) an elapsed time since a previous unsuccessful call routing attempt to each of the alternate target PSAPs, (iii) a location of each of the alternate target PSAPs, or (iv) an operational state of each of the alternate target PSAPs.

6. The call routing device of claim 1, the set of operations further comprising:
in response to detecting the potential call routing loop, sending an indication of the potential call routing loop to the second PSAP.

7. The call routing device of claim 6, the set of operations further comprising, after determining that the first routing attempt is unsuccessful and prior to performing the second routing attempt:
performing a third routing attempt to route the emergency call to a fourth PSAP from among the plurality of PSAPs;
determining that the third routing attempt is unsuccessful;
identifying the first PSAP as a subsequent target PSAP for the emergency call;
detecting an additional potential call routing loop based on both (i) determining that the first routing attempt to route the emergency call to the first PSAP is unsuccessful and (ii) identifying the first PSAP as the subsequent target PSAP for the emergency call; and
in response to detecting the additional potential call routing loop, selecting from among the plurality of PSAPs an alternate next target PSAP for the emergency call, wherein selecting the alternate next target PSAP comprises selecting a PSAP that was not a target PSAP in the potential call routing loop, and wherein selecting the alternate next target PSAP comprises selecting the second PSAP.

8. A method for routing calls to public safety answering points (PSAPs), the method comprising:
maintaining a call routing log that identifies a set of previous call routing attempts for a plurality of PSAPs communicatively coupled to a call routing device;
receiving call data identifying an emergency call;
based on the call data, selecting a first PSAP from among the plurality of PSAPs to receive the emergency call;
performing a first routing attempt to route the emergency call to the first PSAP;
determining that the first routing attempt is unsuccessful;
based on determining that the first routing attempt is unsuccessful, performing a second routing attempt to route the emergency call to a second PSAP from among the plurality of PSAPs;
determining that the second routing attempt is successful;
updating the call routing log to reflect the unsuccessful first routing attempt and the successful second routing attempt;
receiving, from the second PSAP, a request to transfer the emergency call from the second PSAP, wherein the request identifies the first PSAP as a target PSAP for the transfer;
detecting a potential call routing loop by determining, based on the call routing log, that a previous call routing attempt for routing the emergency call to the first PSAP was unsuccessful;
in response to detecting the potential call routing loop, identifying, from among the plurality of PSAPs, a list of alternate target PSAPs for the call transfer from the first PSAP, wherein identifying the list of alternate target PSAPs comprises (i) determining, based on the call routing log, whether a given PSAP was a target PSAP of an unsuccessful call routing attempt for the emergency call, (ii) including the given PSAP in the list of alternate target PSAPs based on the given PSAP not being the target PSAP of an unsuccessful call routing attempt for the emergency call, and (iii) excluding the given PSAP from the list of alternate target PSAPs based on the given PSAP being the target PSAP of an unsuccessful call routing attempt for the emergency call;
providing the list of alternate target PSAPs to the second PSAP;
receiving, from the second PSAP, a selection of a third PSAP from among the list of alternate target PSAPs; and
transferring the call from the second PSAP to the third PSAP.

9. The method of claim 8, wherein identifying the list of alternate target PSAPs further comprises:
determining an operational state of the given PSAP;
including the given PSAP in the list of alternate target PSAPs based on both (i) the given PSAP not being the target of an unsuccessful call routing attempt for the emergency call and (ii) the operational state of the given PSAP indicating that the given PSAP is capable of receiving the emergency call; and
excluding the given PSAP from the list of alternate target PSAPs based on either (i) the given PSAP being the target of an unsuccessful call routing attempt for the emergency call or (ii) the operational state of the given PSAP indicating that the given PSAP is capable of receiving the emergency call.

10. The method of claim 8, further comprising:
prioritizing each of the alternate target PSAPs in the list of alternate target PSAPs based on at least one of (i) an elapsed time since a recent successful call routing attempt to each of the alternate target PSAPs, (ii) an elapsed time since a recent unsuccessful call routing attempt to each of the alternate target PSAPs, (iii) a location of each of the alternate target PSAPs, or (iv) an operational state of each of the alternate target PSAPs, wherein providing the list of alternate target PSAPs to the first PSAP comprises providing the list of alternate target PSAPs in their prioritized order.

11. The method of claim 8, further comprising:
prioritizing each of the alternate target PSAPs using a machine learning model trained to predict a likelihood of success of transferring the call from the second PSAP to each of the alternate target PSAPs, wherein providing the list of alternate target PSAPs to the second PSAP comprises providing the list of alternate target PSAPs in their prioritized order.

12. The method of claim 11, wherein the machine learning model is configured to receive, as input feature data, data indicating at least one of (i) an elapsed time since a previous successful call routing attempt to each of the alternate target PSAPs, (ii) an elapsed time since a previous unsuccessful call routing attempt to each of the alternate target PSAPs, (iii) a location of each of the alternate target PSAPs, or (iv) an operational state of each of the alternate target PSAPs.

13. The method of claim 8, further comprising:
in response to detecting the potential call routing loop, sending an indication of the potential call routing loop to the second PSAP.

14. The method of claim 8, further comprising, after determining that the first routing attempt is unsuccessful and prior to performing the second routing attempt:
performing a third routing attempt to route the emergency call to a fourth PSAP from among the plurality of PSAPs;
determining that the third routing attempt is unsuccessful;
identifying the first PSAP as a subsequent target PSAP for the emergency call;
detecting an additional potential call routing loop based on both (i) determining that the first routing attempt to route the emergency call to the first PSAP is unsuccessful and (ii) identifying the first PSAP as the subsequent target PSAP for the emergency call; and
in response to detecting the additional potential call routing loop, selecting from among the plurality of PSAPs an alternate next target PSAP for the emergency call, wherein selecting the alternate next target PSAP comprises selecting a PSAP that was not a target PSAP in the potential call routing loop, and wherein selecting the alternate next target PSAP comprises selecting the second PSAP.

15. A system comprising:
a plurality of public safety answering points (PSAPs) including a first PSAP, a second PSAP, and a third PSAP; and
a call routing device communicatively coupled to the plurality of PSAPs, the call routing device configured to perform a set of operations comprising:
maintaining a call routing log that identifies a set of previous call routing attempts for a plurality of PSAPs communicatively coupled to the call routing device;
receiving call data identifying an emergency call;
based on the call data, selecting a first PSAP from among the plurality of PSAPs to receive the emergency call;
performing a first routing attempt to route the emergency call to the first PSAP;
determining that the first routing attempt is unsuccessful;
based on determining that the first routing attempt is unsuccessful, performing a second routing attempt to route the emergency call to a second PSAP from among the plurality of PSAPs;
determining that the second routing attempt is successful;
updating the call routing log to reflect the unsuccessful first routing
attempt and the successful second routing attempt;
receiving, from the second PSAP, a request to transfer the emergency call from the second PSAP, wherein the request identifies the first PSAP as a target PSAP for the transfer;
detecting a potential call routing loop by determining, based on the call routing log, that a previous call routing attempt for routing the emergency call to the first PSAP was unsuccessful;
in response to detecting the potential call routing loop, identifying, from among the plurality of PSAPs, a list of alternate target PSAPs for the call transfer from the first PSAP, wherein identifying the list of alternate target PSAPs comprises (i) determining, based on the call routing log, whether a given PSAP was a target PSAP of an unsuccessful call routing attempt for the emergency call, (ii) including the given PSAP in the list of alternate target PSAPs based on the given PSAP not being the target PSAP of an unsuccessful call routing attempt for the emergency call, and (iii) excluding the given PSAP from the list of alternate target PSAPs based on the given PSAP being the target PSAP of an unsuccessful call routing attempt for the emergency call;
providing the list of alternate target PSAPs to the second PSAP;
receiving, from the second PSAP, a selection of a third PSAP from among the list of alternate target PSAPs; and
transferring the call from the second PSAP to the third PSAP.

16. The system of claim 15, wherein identifying the list of alternate target PSAPs further comprises:
determining an operational state of the given PSAP;
including the given PSAP in the list of alternate target PSAPs based on both (i) the given PSAP not being the target of an unsuccessful call routing attempt for the emergency call and (ii) the operational state of the given PSAP indicating that the given PSAP is capable of receiving the emergency call; and
excluding the given PSAP from the list of alternate target PSAPs based on either (i) the given PSAP being the target of an unsuccessful call routing attempt for the emergency call or (ii) the operational state of the given PSAP indicating that the given PSAP is capable of receiving the emergency call.

17. The system of claim 15, the set of operations further comprising:
prioritizing each of the alternate target PSAPs in the list of alternate target PSAPs based on at least one of (i) an elapsed time since a recent successful call routing attempt to each of the alternate target PSAPs, (ii) an elapsed time since a recent unsuccessful call routing attempt to each of the alternate target PSAPs, (iii) a location of each of the alternate target PSAPs, or (iv) an operational state of each of the alternate target PSAPs, wherein providing the list of alternate target PSAPs to the first PSAP comprises providing the list of alternate target PSAPs in their prioritized order.

18. The system of claim 15, the set of operations further comprising:
prioritizing each of the alternate target PSAPs using a machine learning model trained to predict a likelihood of success of transferring the call from the second PSAP to each of the alternate target PSAPs, wherein providing the list of alternate target PSAPs to the second PSAP comprises providing the list of alternate target PSAPs in their prioritized order.

19. The system of claim 18, wherein the machine learning model is configured to receive, as input feature data, data indicating at least one of (i) an elapsed time since a previous successful call routing attempt to each of the alternate target PSAPs, (ii) an elapsed time since a previous unsuccessful call routing attempt to each of the alternate target PSAPs, (iii) a location of each of the alternate target PSAPs, or (iv) an operational state of each of the alternate target PSAPs.

20. The system of claim 15, wherein the plurality of PSAPs further comprises a fourth PSAP, and wherein the set of operations further comprise, after determining that the first routing attempt is unsuccessful and prior to performing the second routing attempt:
performing a third routing attempt to route the emergency call to the fourth PSAP;
determining that the third routing attempt is unsuccessful;
identifying the first PSAP as a subsequent target PSAP for the emergency call;
detecting an additional potential call routing loop based on both (i) determining that the first routing attempt to route the emergency call to the first PSAP is unsuccessful and (ii) identifying the first PSAP as the subsequent target PSAP for the emergency call; and
in response to detecting the additional potential call routing loop, selecting from among the plurality of PSAPs an alternate next target PSAP for the emergency call, wherein selecting the alternate next target PSAP comprises selecting a PSAP that was not a target PSAP in the potential call routing loop, and wherein selecting the alternate next target PSAP comprises selecting the second PSAP.
